(19) United States
(12) Patent Application Publication
(10) Pub. No.: US 2025/0060278 A1
(43) Pub. Date: Feb. 20, 2025

(54) SENSOR ARRANGEMENT FOR SLIP DETECTION ON A CLUTCH, A CLUTCH WITH SUCH A SENSOR ARRANGEMENT AND A UNIVERSAL JOINT SHAFT WITH SUCH A CLUTCH

(71) Applicant: Walterscheid GmbH, Lohmar (DE)

(72) Inventors: Thomas JUNG, Bonn (DE); Max KRÜGER, Lohmar (DE)

(73) Assignee: Walterscheid GmbH, Lohmar (DE)

(21) Appl. No.: 18/804,415

(22) Filed: Aug. 14, 2024

(30) Foreign Application Priority Data
Aug. 17, 2023 (EP) 23191834.3

(51) Int. Cl. G01M 13/022; G01P 3/44

(52) U.S. Cl. CPC G01M 13/022; G01P 3/44

(57) ABSTRACT

Sensor arrangement for detecting slip between first and second clutch elements of a clutch includes: a magnetic field source generating an initial magnetic field; a first magnetic field influencing element connectable to or configured integrally with the first clutch element; a second magnetic field influencing element connectable to or configured integrally with the second clutch element; and a magnetic field sensor configured to measure a parameter characterizing a superimposed magnetic field. The magnetic field source, the first magnetic field influencing element and the second magnetic field influencing element are arranged such that the initial magnetic field of the magnetic field source from the first magnetic field influencing element and from the second magnetic field influencing element is converted into the superimposed magnetic field. An evaluation unit determines the slip of the clutch from the parameter and generates a signal characterizing a state of the clutch based on the slip.

### CROSS-REFERENCE TO RELATED APPLICATION

This application claims priority to and the benefit of EP 23191834.3 filed on Aug. 17, 2023, the disclosures of which is incorporated herein by reference in its entirety.

### FIELD

The present disclosure relates to a sensor arrangement for slip detection on a clutch with a first clutch element and a second clutch element which can be coupled with the first clutch element.

### BACKGROUND

The statements in this section merely provide background information related to the present disclosure and may not constitute prior art.

If driven machines block abruptly, the resulting torques can exceed the nominal torques of the driven machine by a multiple due to the rotating masses to be braked and thus cause serious damage to the driven machine. Safety clutches protect these machines from such torque shocks. The clutch separates both sides of the drive train at least temporarily when a limit torque is reached. The separation can be permanent, for example in the case of shear bolt clutches, or the relative rotation of two parts of the clutch to each other can be made possible temporarily, as for example in the overload slip clutch shown in DE 10 139 576 A1.

DE 39 06 050 A1 discloses a drive train of an agricultural machine with an overload slip clutch that connects a universal joint shaft driven by a tractor to a working machine attached to the tractor. The clutch is monitored by a sensor arrangement for slip detection, which has a first rotational speed sensor connected to an input part of the clutch and a second rotational speed sensor connected to an output part of the clutch. Each rotational speed sensors comprise a toothed disk mounted on the input part and a toothed disk mounted on the output part and an inductive tachometer. The slip in the clutch can be determined by detecting speed differences between the input part and the output part.

### SUMMARY

This section provides a general summary of the disclosure and is not a comprehensive disclosure of its full scope or all of its features.

In view of this, an object of the present disclosure is to provide a sensor arrangement for detecting slip in a clutch, which is space-saving and enables a space-optimized arrangement in the clutch. A further object of the present disclosure is to provide a clutch, in particular for a universal joint shaft, with such a sensor arrangement and to provide a universal joint shaft with such a clutch.

The object is achieve by a sensor arrangement for slip detection on a clutch with a first clutch element and a second clutch element which can be coupled to the first clutch element is proposed, comprising a magnetic field source that generates an initial magnetic field, a first magnetic field influencing element which can be connected to the first clutch element or is designed integrally with the first clutch element, a second magnetic field influencing element which can be connected to the second clutch element or is designed integrally with the second clutch element, wherein the magnetic field source, the first magnetic field influencing element and the second magnetic field influencing element are arranged relative to one another in such a way that the initial magnetic field of the magnetic field source is converted into a superimposed magnetic field by the first magnetic field influencing element and by the second magnetic field influencing element, and a magnetic field sensor which is designed to detect a change in the superimposed magnetic field by means of a parameter characterizing the superimposed magnetic field, wherein the magnetic field source can be connected to one of the first clutch element and the second clutch element.

The sensor arrangement can be used in particular on an overload clutch of a universal joint shaft.

A magnetic field influencing element can, for example, be a separate element that has an increased magnetic permeability or a reduced magnetic permeability compared to the respective associated clutch element. In another embodiment, a magnetic field influencing element can be a section of the respective clutch element that has an increased magnetic permeability or a reduced magnetic permeability relative to another section, in particular relative to the rest, of the respective associated clutch element. The section of the respective clutch element designed as a magnetic field influencing element can have a shape that deviates from rotational symmetry, particularly with regard to the axis of rotation of the clutch element. In particular, a magnetic field influencing element can be a ferromagnetic section of the respective clutch element. A magnetic field influencing element can also be designed as a magnetic field source, for example as a magnetic element or as a magnetized section of the respective clutch element.

In a possible embodiment, the magnetic field sensor can be designed to measure the parameter characterizing the superimposed magnetic field at a measurement point. The measurement point can be defined by the spatial arrangement and the structure of the magnetic field sensor. It is understood that the measurement point is not to be understood restrictively as a non-extended or infinitesimal location in a room, but can also be defined by a measurement surface in the room. The sensor arrangement can have exactly one magnetic field sensor. However, it is also conceivable that several magnetic field sensors each measure a parameter that characterizes the superimposed magnetic field.

In particular, the magnetic field sensor can be designed to measure the magnitude of the magnetic field strength or the magnitude of the magnetic flux density as a characteristic parameter at the measurement point. Alternatively or in combination, the magnetic field sensor can be designed to measure the orientation of the superimposed magnetic field as a characteristic parameter at the measurement point. In particular, the magnetic field sensor can be designed to measure at least one coordinate of a vector of magnetic field strength or of a vector of magnetic flux density. It is thus understood that the magnetic field sensor can be designed to measure one, two or three coordinates of the vector of the magnetic field strength or the vector of the magnetic flux density, the coordinate axes being in particular axes of an orthogonal coordinate system. The characteristic parameter of the superimposed magnetic field can therefore be, for example, the magnetic field strength, the magnetic flux density or the orientation of the superimposed magnetic field. The magnetic field sensor can be designed to determine the change in the characteristic parameter over time.

In a possible embodiment, an evaluation unit can be provided, which is designed to determine the slip of the clutch from the parameter characterizing the superimposed magnetic field. The slip of the clutch is defined by the relative speed difference between the first clutch element and the second clutch element.

The evaluation unit can be designed to generate a signal that characterizes the state of the clutch depending on the slip determined. The condition of the clutch can be described in particular by one or more values of the relative speed between the first clutch element and the second clutch element, the slip between the first clutch element and the second clutch element, the temperature of the clutch or individual clutch elements and the wear of individual clutch elements.

The evaluation unit can be connected to an external control unit. The external control unit can, for example, be the control unit of a drive arrangement or an output arrangement.

In a possible embodiment, the magnetic field sensor can be arranged at least temporarily within the superimposed magnetic field. This can be the case, for example, if the magnetic field source is arranged so that it can rotate relative to the magnetic field sensor. In this case, the superimposed magnetic field rotates around an axis of rotation and the magnetic field sensor passes through the superimposed magnetic field with each revolution.

In a possible embodiment, the magnetic field sensor can be attached to an element that is fixed in relation to the axis of rotation or the coupling. This has the advantage that a simple wired connection to the evaluation unit can be established. Alternatively, it is conceivable that the magnetic field sensor can be connected to one of the first clutch element and the second clutch element, whereby the magnetic field sensor is permanently arranged in the superimposed magnetic field in the basic state of the coupling. The basic state of the clutch is the state in which the first clutch element and the second clutch element are not rotated relative to each other with respect to an initial position. In this configuration, the magnetic field sensor is arranged to rotate and the signal from the magnetic field sensor must be taken from the rotating part accordingly. This is possible, for example, using a sliding contact or a wireless connection.

In a possible embodiment, the magnetic field source can be designed as a separate magnetic element, for example as a ring magnet or bar magnet. Alternatively, the magnetic field source can be designed integrally with one of the first clutch element and the second clutch element. For example, the magnetic field source can be a magnetized section of the corresponding clutch element.

In a further possible embodiment, the first magnetic field influencing element and/or the second magnetic field influencing element can be designed as a further magnetic field source. The additional magnetic field source can in particular be a separate magnetic element. Alternatively, the additional magnetic field source can be designed integrally with one of the first clutch element and the second clutch element. For example, the additional magnetic field source can be a magnetized section of the corresponding clutch element.

In a possible embodiment, the magnetic field source and/or the further magnetic field source can be a permanent magnet or an electromagnet.

A clutch, in particular for a universal joint shaft, may be provided to achieve the object of the disclosure, comprising: a first clutch element, a second clutch element which can be coupled to the first clutch element, a sensor arrangement in a previously described embodiment, wherein the first magnetic field influencing element is connected to the first clutch element or is integrally formed with the first clutch element, wherein the second magnetic field influencing element is connected to the second clutch element or is integrally formed with the second clutch element, and wherein the magnetic field source is connected to or integral with one of the first clutch element and the second clutch element.

In a possible embodiment, the clutch can be arranged to rotate about an axis of rotation. The first clutch element and the second clutch element can be arranged to rotate about the axis of rotation relative to the magnetic field sensor.

In a possible embodiment of the clutch, the magnetic field sensor can be attached or fastened to an element that is stationary relative to the axis of rotation or the clutch. Alternatively, the magnetic field sensor can be permanently connected to one of the first clutch element and the second clutch element.

In a possible embodiment of the coupling, the magnetic field sensor can be arranged at a greater distance from the axis of rotation than the first magnetic field influencing element and the second magnetic field influencing element. Alternatively or in combination, the magnetic field sensor can be arranged outside both a cylindrical envelope of the first clutch element coaxial with the axis of rotation and a cylindrical envelope of the second clutch element coaxial with the axis of rotation.

In a possible embodiment of the clutch, the first magnetic field influencing element and/or the second magnetic field influencing element can be designed as a further magnetic field source. The additional magnetic field source can be connected to or integral with one of the first clutch element and the second clutch element.

In a possible embodiment, the clutch can comprise a guard element which is arranged at least partially around the first clutch element and/or the second clutch element, wherein the magnetic field sensor is attached to the guard element. For example, the magnetic field sensor can be attached to the safety shield of a universal joint shaft.

According to a further aspect, a universal joint shaft assembly may comprise a rotatably arranged universal joint shaft element, and a clutch in a previously described embodiment, wherein the universal joint shaft element is connected to the first clutch element.

According to another aspect of the disclosure a method for detecting slip between a first clutch element and a second clutch element of a clutch is provided. The method comprises: arranging a magnetic field source at one of the first clutch element and the second clutch element, wherein the magnetic field source generates an initial magnetic field; providing a first magnetic field influencing element on the first clutch element or as an integral part of the first clutch element; providing a second magnetic field influencing element on the second clutch element or as an integral part of the second clutch element; arranging the magnetic field source, the first magnetic field influencing element and the second magnetic field influencing element relative to one another such that the initial magnetic field is converted into a superimposed magnetic field by; and detecting a change in the superimposed magnetic field on the basis of a parameter characterizing the superimposed magnetic field.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view of a tractor connected to an implement via a universal joint shaft assembly;

FIG. 2 is a schematic sectional view of the universal joint shaft assembly from FIG. 1 in the area of the connection to the implement;

FIG. 3 is a sectional view of the clutch from FIG. 1;

FIG. 4 is a sectional view of the clutch from FIG. 1 in a second embodiment;

FIG. 5 is a sectional view of the clutch from FIG. 1 in a third embodiment; and

FIG. 6 is a sectional view of the clutch from FIG. 1 in a fourth embodiment.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

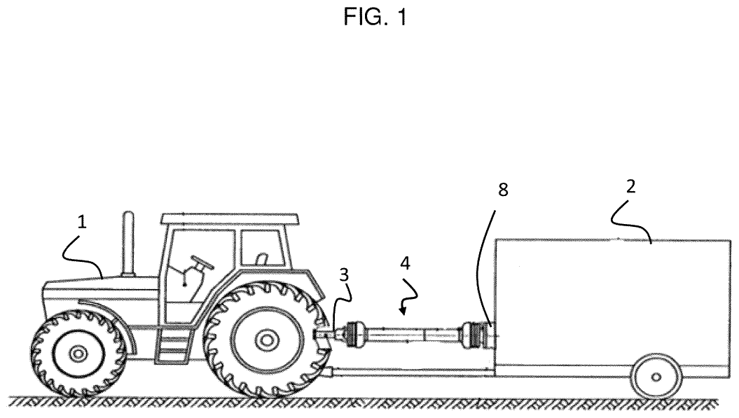

FIG. 1 shows a tractor 1 with an attached implement 2. The implement 2 is driven by the power take-off shaft (PTO) 3 of the tractor 1 by means of a universal joint shaft assembly 4. For this purpose, the universal joint shaft assembly 4 is attached to the power take-off shaft 3 and connected with it in a rotationally fixed manner. On the implement side, the universal joint shaft assembly 4 is also drive-connected to a drive element of a gearbox 8 of the implement 2.

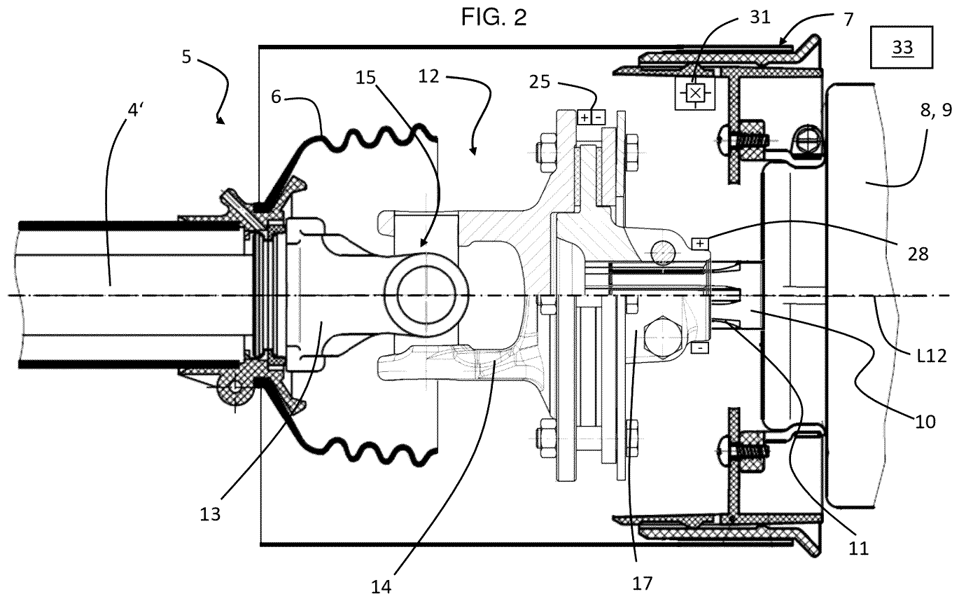

FIG. 2 shows the universal joint shaft assembly 4 in a schematic overview sketch. The universal joint shaft assembly 4 comprises a shaft yoke 13 and a clutch yoke 14, which are connected to each other in a known cardanic manner via a cross kit 15. The shaft yoke 13 and the clutch yoke 14 each have apertures in yoke sections in which the cross kit 15 is inserted. The shaft yoke 13 is non-rotatably connected to a shaft 4′ of the universal joint shaft assembly 4. The clutch yoke 14 is detachably connected to an input shaft 10 of the gearbox 8 via a clutch 12. The clutch 12 is arranged to rotate about an axis of rotation L12.

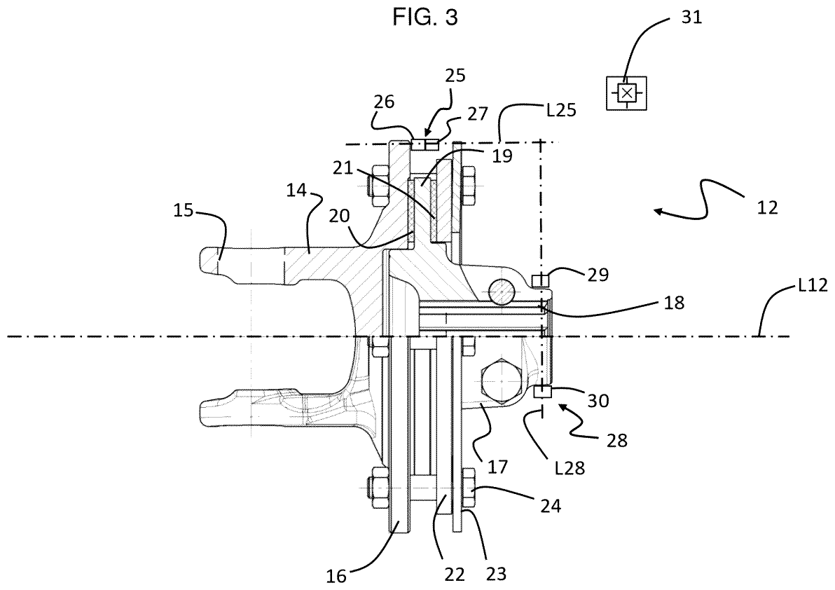

As can be seen from the conjunction of FIGS. 2 and 3, the clutch 12 has a first clutch element and a second clutch element, which are coupled to one another in such a way that a relative rotational movement of the two clutch elements to one another can take place when a maximum torque is exceeded.

The first clutch element is designed as a clutch flange 16, into which the clutch yoke 14 is integrated. The second clutch element is designed as an output element 17. The output element 17 comprises internal splines 18, into which complementary external splines 11 of the input shaft 10 of the gearbox 8 is inserted. The output element 17 and the input shaft 10 of the gearbox 8 are thus connected to each other in a rotationally fixed manner.

The output element 17 has a friction flange 19, which is at least indirectly frictionally connected to the clutch flange 16. For this purpose, the clutch 12 also comprises a first friction lamella 20, a second friction lamella 21, a thrust ring 22 and a spring washer 23.

The first friction lamella 20 is arranged or clamped between the clutch flange 16 and the friction flange 19 of the output element 17. The first friction lamella 20 is thus in contact with the friction flange 19 on a first axial side of the latter. It is also conceivable that the first friction lamella 20 is firmly connected to the clutch flange 16.

On a second axial side of the friction flange 19, the second friction lamella 21 is in contact with the friction flange 19. The friction flange 19 is thus clamped between the first friction lamella 20 and the second friction lamella 21 and is held by these in a frictionally engaged manner in the circumferential direction. The second friction lamella 21 is arranged between the friction flange 19 and the thrust ring 22 or clamped between them. It is also conceivable that the second friction lamella 21 is firmly connected to the thrust ring 22. The thrust ring 22 is arranged or clamped between the second friction lamella 21 and the spring washer 23. It is also conceivable that the thrust ring 22 is firmly connected to the spring washer 23.

The spring washer 23 applies a compressive force in the axial direction to the thrust ring 22, the second friction lamella 21, the friction flange 19, the first friction lamella 20 and the clutch flange 16, so that the aforementioned elements are braced together. For this purpose, one or more clamping means 24 extend through an aperture in the spring washer 23 and through an aperture in the clutch flange 16. In the present case, the clamping means 24 are designed as a screw that is secured by a nut. The clamping force is applied to the screw by tightening the nut. The clamping means 24 are arranged in such a way that a rotary movement of the friction flange 19 about the axis of rotation L12 can take place at least in a circumferential section without the friction flange 19 coming into contact with the clamping means 24.

The clutch 12 has a first magnet 25 as a magnetic field source 25, which in the present case is attached to the clutch flange 16. The first magnet 25 can be inserted into a recess in the clutch flange 16 or bonded to the clutch flange 16. Alternatively, the first magnet 25 can be cast into the clutch flange 16. It is also conceivable that the first magnet 25 is integrated into the clutch flange 16. For example, an outer circumferential section of the clutch flange 16 can be magnetized and form the first magnet. However, the first magnet 25 could in principle also be attached to or integrated in one of the elements first friction lamella 20, second friction lamella 21, thrust ring 22 and spring washer 23.

The first magnet 25 comprises a north pole 26 and a south pole 27. The first magnet 25 is designed as a bar magnet, with the imaginary straight connection of the north pole 26 and the south pole 27 defining a longitudinal axis L25 of the first magnet 25. The longitudinal axis L25 is arranged parallel to the axis of rotation L12.

In the embodiment shown, the first magnet 25 represents a magnetic field source of a sensor arrangement which is designed to determine the slip or a relative rotational speed between the clutch flange 16 and the output element 17. The magnetic field source or the first magnet 25 generate an initial magnetic field of the sensor arrangement.

The first clutch element or the clutch flange 16 has ferromagnetic properties, at least in sections, so that the field lines of the initial magnetic field of the magnetic field source are influenced or guided by the clutch flange 16. The ferromagnetic sections of the clutch flange 16 thus represent a first magnetic field influencing element of the sensor arrangement.

A second magnet 28 is attached to the output element 17 as a second magnetic field influencing element 28. The second magnet 28 is designed as a ring magnet, which is arranged on an outer circumferential surface of the output element 17. The second magnet 28 is, for example, glued or screwed to the output element 17. Alternatively, the second magnet 28 can be cast into the output element 17. It is also conceivable that the second magnet 28 is integrated into the output element 17. For example, an outer circumferential section of the output element 17 can be magnetized and form the second magnet.

The second magnet 28 comprises a north pole 29 and a south pole 30, with the imaginary straight connection of the north pole 29 and the south pole 30 defining a longitudinal axis L28 of the second magnet 28. The longitudinal axis L28 is arranged in a radial plane with respect to the axis of rotation L12. In FIGS. 2 and 3, the clutch 12 is shown in an initial position in which the clutch flange 16 and the output element 17 are arranged in a respective mounting position without being rotated relative to one another in order to explain the operation of the sensor arrangement by way of example. It is understood that the function of the sensor arrangement is not limited to this initial position. In the initial position, the longitudinal axis L25 of the first magnet 25 and the longitudinal axis L28 of the second magnet 28 intersect at a point of intersection. The south pole 27 of the first magnet 25 and the north pole 29 of the second magnet 28 face the intersection point in the starting position. This means that opposite poles of the first magnet 25 and the second magnet 28 face the point of intersection. In another possible embodiment, the same poles of the first magnet 25 and the second magnet 28 can each face the intersection point.

The magnetic field of the second magnet 28 changes the course of the field lines of the initial magnetic field of the magnetic field source or the first magnet 25. The second magnet 28 thus represents a second magnetic field influencing element of the sensor arrangement.

The first magnet 25, the clutch flange 16 as the first magnetic field influencing element and the second magnet 28 as the second magnetic field influencing element are arranged relative to one another in such a way that the initial magnetic field is converted into a superimposed magnetic field.

FIG. 2 also shows the positioning of a magnetic field sensor 31, which is designed to measure a parameter characterizing the superimposed magnetic field. The parameter can be, for example, the magnetic flux, the magnetic density or the orientation of the superimposed magnetic field at the measurement point of the magnetic field sensor 31.

The universal joint shaft assembly 4 comprises a guard device 5, which has a guard cone 6 and a safety shield 7. The guard cone 6 surrounds the universal joint with the shaft yoke 13, the clutch yoke 14 and the cross kit 15 at least partially and is arranged inside the safety shield 7. The safety shield 7 is firmly connected to a housing 9 of the gearbox 8 and extends along the axis of rotation L12, so that the safety shield 7 and the clutch 12 are arranged in axial overlap with one another.

The magnetic field sensor 31 is attached to a stationary component which, in particular, does not rotate with the clutch 12 about the axis of rotation L12. As can be seen from FIG. 2, the magnetic field sensor 31 is actually attached to the safety shield 7 on the gearbox side. However, it is also conceivable that the magnetic field sensor 31 is attached at any point on the safety shield 7. For example, the magnetic field sensor 31 can be attached to the safety shield 7 in such a way that the magnetic field sensor 31 is arranged at least partially in a radial plane with the first magnet 25 and/or in a radial plane with the second magnet 28. Alternatively, the magnetic field sensor 31 can also be attached directly to the housing 9 of the gearbox 8.

In the present disclosure, the magnetic field sensor 31 is designed to measure the orientation of the superimposed magnetic field in the measurement point of the magnetic field sensor 31. For this purpose, the magnetic field sensor 31 detects at least one coordinate of a vector of the magnetic field strength or a vector of the magnetic flux density of the superimposed magnetic field in an orthogonal coordinate system. The coordinate system is defined by the axis of rotation L12 and the shortest connection between the measurement point and the axis of rotation L12. In the present case, the magnetic field sensor 31 detects a coordinate that is directed in the radial direction with respect to the axis of rotation L12. It is understood that alternatively a magnetic field sensor 31 can also be used, which measures two or three coordinates of the vector.

To evaluate the signal from the magnetic field sensor 31, it is connected to an evaluation unit 33. In this case, the connection between the magnetic field sensor 31 and the evaluation unit 33 is wired. However, it is also conceivable that the connection is wireless.

The evaluation unit 33 is designed to determine a state of the clutch from the parameter characterizing the superimposed magnetic field. The evaluation unit 33 is also designed to generate a signal that characterizes the state of the clutch depending on the determined state. The evaluation unit 33 can also be connected or is connected to a control unit of the tractor 1. The control unit of the tractor 1 can thus control the power supplied to the universal joint shaft assembly 4 via the power take-off shaft 3 as a function of the signal transmitted by the evaluation unit 33.

If the clutch 12 is subjected to a torque that exceeds a threshold value, the friction flange 19 slips between the first friction lamella 20 and the second friction lamella 21 in the circumferential direction. The first magnet 25 and the second magnet 28 are thus displaced or rotated relative to each other in the circumferential direction. The longitudinal axis L25 of the first magnet 25 and the longitudinal axis L28 of the second magnet 28 are subsequently arranged out of phase with one another. In addition, the ferromagnetic sections of the clutch flange 16 or the first magnetic field influencing element have rotated about the longitudinal axis L12 with respect to the second magnet 28 or the second magnetic field influencing element. This changes the orientation and local intensity of the superimposed magnetic field. This change can be detected at the measurement point by the magnetic field sensor 31 and thus a relative speed or slip between the first clutch element 16 and the second clutch element 17 can be detected. The superimposed magnetic field rotates with the clutch 12 around the axis of rotation L12. The magnetic field sensor 31 therefore passes through the superimposed magnetic field once per revolution. The magnetic field sensor and/or the evaluation unit 33 can detect the change in the superimposed magnetic field per revolution.

The first magnet 25, the clutch flange 16, the second magnet 28 and the magnetic field sensor 31 are thus part of a sensor arrangement for slip detection of the clutch 12. The sensor arrangement comprises exactly one magnetic field sensor. This is sufficient to determine the slip of the clutch. However, it is also conceivable that the sensor arrangement has several magnetic field sensors, each of which is designed to measure a parameter characterizing the superimposed magnetic field. This means that the sensor arrangement can be protected redundantly or the resolution of the sensor arrangement can be increased.

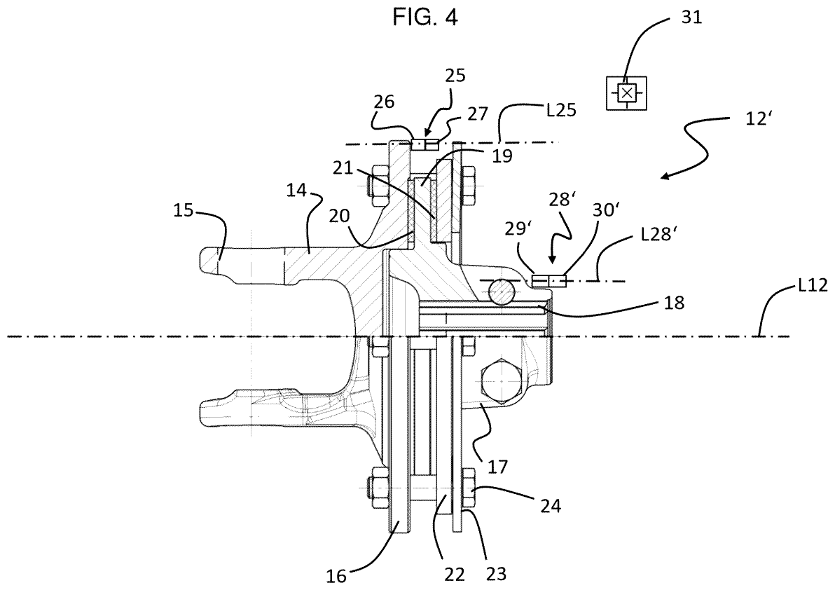

FIG. 4 shows a clutch 12′ in a second embodiment. The second embodiment of the clutch 12′ differs from the first embodiment 12 only in the arrangement of the sensor arrangement, whereby the structure of the rest of the clutch is identical. In this respect, identical or similar parts are identified with the same reference signs and reference is made in this respect to the description in the context of the first embodiment.

The sensor arrangement of the second embodiment also comprises the first magnet 25 and the magnetic field sensor 31, with a modified second magnet 28′ being provided. The second magnet 28′ is designed as a bar magnet instead of a ring magnet and is firmly connected to the output element 17 of the clutch 12′. The second magnet 28′ therefore also rotates with the clutch 12′ around the axis of rotation L12.

The second magnet 28′ comprises a north pole 29′ and a south pole 30′, with the imaginary straight connection of the north pole 29′ and the south pole 30′ defining a longitudinal axis L28′ of the second magnet 28. The longitudinal axis L28′ is arranged parallel to the axis of rotation L12 and to the longitudinal axis L25 of the first magnet 25.

In FIG. 4, the clutch 12′ is shown in an initial position in which the clutch flange 16 and the output element 17 are arranged non-rotated relative to each other in a respective mounting position in order to explain the operation of the sensor arrangement by way of example. It is understood that the function of the sensor arrangement is not limited to this initial position. The longitudinal axis L25 of the first magnet 25, the longitudinal axis L28′ of the second magnet 28′ and the axis of rotation L12 are arranged in a common plane in the initial position.

If the clutch 12′ is subjected to a torque that exceeds a threshold value, the friction flange 19 slips between the first friction lamella 20 and the second friction lamella 21 in the circumferential direction. The first magnet 25 and the second magnet 28 are thus displaced or spaced apart relative to each other in the circumferential direction. The longitudinal axis L25 of the first magnet 25, the longitudinal axis L28′ of the second magnet 28′ and the axis of rotation L12 are subsequently no longer arranged in a common plane. In addition, the ferromagnetic sections of the clutch flange 16 or the first magnetic field influencing element have rotated about the longitudinal axis L12 with respect to the second magnet 28′ or the second magnetic field influencing element. This changes the orientation and local intensity of the superimposed magnetic field. This change can be detected at the measurement point by the magnetic field sensor 31.

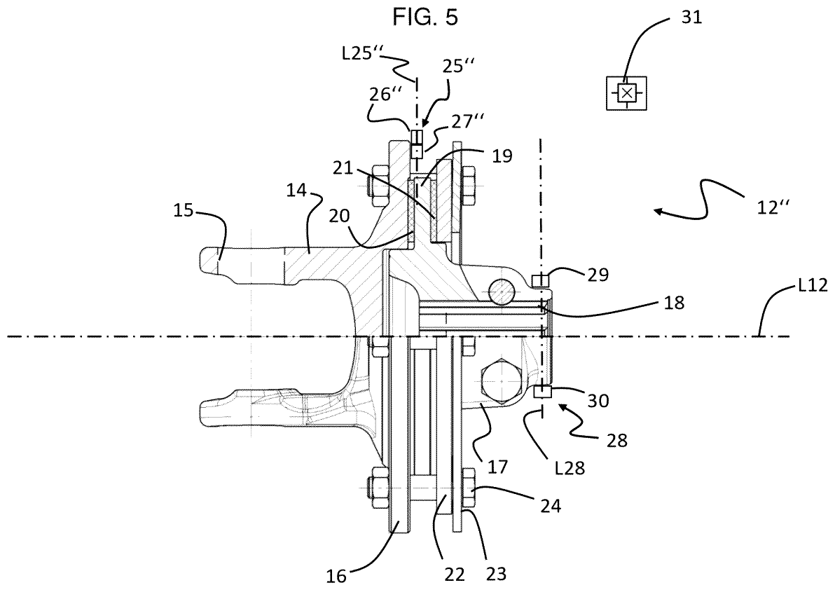

FIG. 5 shows a clutch 12″ in a third embodiment. The third embodiment of the clutch 12′ differs from the first embodiment 12 only in the arrangement of the sensor arrangement, whereby the structure of the rest of the clutch is identical. In this respect, identical or similar parts are identified with the same reference signs and reference is made in this respect to the description in the context of the first embodiment.

The sensor arrangement of the third embodiment also comprises the second magnet 28 and the magnetic field sensor 31, wherein a modified first magnet 25″ is provided. The first magnet 25″ is designed as a bar magnet and is firmly connected to the clutch flange 16 of the clutch 12″.

The first magnet 25″ comprises a north pole 26″ and a south pole 27″, wherein the imaginary straight connection of the north pole 26″ and the south pole 27″ defines a longitudinal axis L25″ of the first magnet 25″. The longitudinal axis L25″ is arranged perpendicular to the axis of rotation L12 and parallel to the longitudinal axis L28 of the second magnet 28.

In FIG. 5, the clutch 12″ is shown in an initial position in which the clutch flange 16 and the output element 17 are arranged non-rotated relative to each other in a respective mounting position in order to explain the operation of the sensor arrangement by way of example. It is understood that the function of the sensor arrangement is not limited to this initial position. The longitudinal axis L25″ of the first magnet 25 and the longitudinal axis L28 of the second magnet 28 are arranged in a common plane with the axis of rotation L12 and in parallel radial planes, which are axially spaced apart.

If the clutch 12″ is subjected to a torque that exceeds a threshold value, the friction flange 19 slips between the first friction lamella 20 and the second friction lamella 21 in the circumferential direction. The first magnet 25″ and the second magnet 28 are thus displaced or rotated relative to each other in the circumferential direction. The longitudinal axis L25″ of the first magnet 25″, the longitudinal axis L28 of the second magnet 28 and the axis of rotation L12 are subsequently no longer arranged in a common plane. In addition, the ferromagnetic sections of the clutch flange 16 or the first magnetic field influencing element have rotated about the longitudinal axis L12 with respect to the second magnet 28 or the second magnetic field influencing element. This changes the orientation and local intensity of the superimposed magnetic field. This change can be detected at the measurement point by the magnetic field sensor 31.

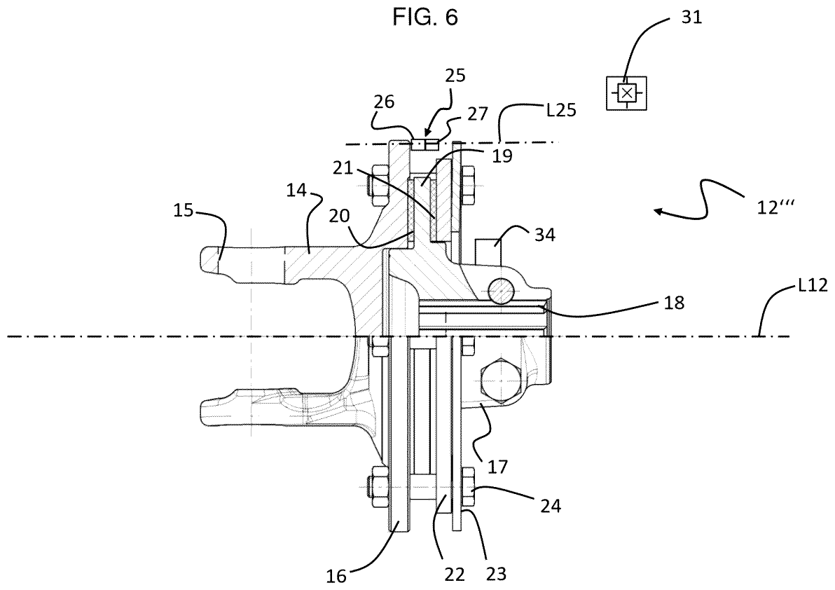

FIG. 6 shows a clutch 12″ in a fourth embodiment. The fourth embodiment of the clutch 12″ differs from the first embodiment 12 only in the arrangement of the sensor arrangement, whereby the structure of the rest of the clutch is identical. In this respect, identical or similar parts are identified with the same reference signs and reference is made in this respect to the description in the context of the first embodiment.

The sensor arrangement of the fourth embodiment also comprises the first magnet 25 and the magnetic field sensor 31, whereby the second magnet 28 is dispensed with as the second magnetic field influencing element. Instead, the output element 17 comprises a ferromagnetic section as the second magnetic field influencing element 34. The ferromagnetic section can have an increased magnetic permeability compared to the remaining output element 17. The ferromagnetic section can either be integrated into the output element 17 or connected to it. The ferromagnetic section as the second magnetic field influencing element 34 thus also rotates with the clutch 12″′ about the axis of rotation L12.

In FIG. 6, the clutch 12″′ is shown in an initial position in which the clutch flange 16 and the output element 17 are arranged without rotation relative to each other in a respective mounting position in order to explain the operation of the sensor arrangement by way of example. It is understood that the function of the sensor arrangement is not limited to this initial position. The longitudinal axis L25 of the first magnet 25, the ferromagnetic section as the second magnetic field influencing element 34 and the axis of rotation L12 are arranged in a common longitudinal plane in the initial position.

If the clutch 12″′ is subjected to a torque that exceeds a threshold value, the friction flange 19 slips between the first friction lamella 20 and the second friction lamella 21 in the circumferential direction. The first magnet 25 and the ferromagnetic section as the second magnetic field influencing element 34 are thus displaced or spaced apart relative to one another in the circumferential direction. The longitudinal axis L25 of the first magnet 25, the ferromagnetic section and the axis of rotation L12 are subsequently no longer arranged in a common plane. In addition, the ferromagnetic sections of the clutch flange 16 or the first magnetic field influencing element have rotated about the longitudinal axis L12 relative to the ferromagnetic section or the second magnetic field influencing element. This changes the orientation and local intensity of the superimposed magnetic field. This change can be detected at the measurement point by the magnetic field sensor 31.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A sensor arrangement for detecting slip between a first clutch element and a second clutch element of a clutch comprising:
a magnetic field source that generates an initial magnetic field;
a first magnetic field influencing element, which is connectable to the first clutch element or is designed integrally with the first clutch element;
a second magnetic field influencing element, which is connectable to the second clutch element or is designed integrally with the second clutch element, wherein the magnetic field source, the first magnetic field influencing element and the second magnetic field influencing element are arranged relative to one another such that the initial magnetic field of the magnetic field source is converted into a superimposed magnetic field by the first magnetic field influencing element and by the second magnetic field influencing element; and
a magnetic field sensor which is designed to detect a change in the superimposed magnetic field by means of a parameter characterizing the superimposed magnetic field,
wherein the magnetic field source is configured to be connected to one of the first clutch element and the second clutch element.

2. The sensor arrangement according to claim 1, wherein the magnetic field sensor is configured to measure the parameter characterizing the superimposed magnetic field at a measurement point.

3. The sensor arrangement according to claim 1, wherein an evaluation unit is configured to determine the slip of the clutch from the parameter characterizing the superimposed magnetic field.

4. The sensor arrangement according to claim 3, wherein the evaluation unit is configured to generate a signal which characterizes a state of the clutch as a function of the slip determined.

5. The sensor arrangement according to claim 3, wherein the evaluation unit is connectable to an external control unit.

6. The sensor arrangement according to claim 1, wherein the magnetic field sensor is arranged at least temporarily within the superimposed magnetic field.

7. The sensor arrangement according to claim 1, wherein at least one of the first magnetic field influencing element and the second magnetic field influencing element is configured as a further magnetic field source, the further magnetic field source being a separate magnetic element.

8. The sensor arrangement according to claim 7, wherein at least one of the magnetic field source and the further magnetic field source is a permanent magnet or an electromagnet.

9. A clutch comprising:
a first clutch element,
a second clutch element which can be coupled with the first clutch element, and
a sensor arrangement according to claim 1,
wherein the first magnetic field influencing element is connected to the first clutch element or is integrally formed with the first clutch element,
wherein the second magnetic field influencing element is connected to the second clutch element or is integrally formed with the second clutch element, and
wherein the magnetic field source is connected to or integral with one of the first clutch element and the second clutch element.

10. The clutch according to claim 9, wherein the clutch is arranged rotatably about an axis of rotation,
wherein the first clutch element and the second clutch element are arranged rotatably relative to the magnetic field sensor, and/or
wherein the magnetic field sensor is fastened to a stationary element, in particular to an element which is stationary with respect to the axis of rotation.

11. The clutch according to claim 10, wherein the magnetic field sensor has a greater distance from the axis of rotation than the first magnetic field influencing element and the second magnetic field influencing element, and/or
wherein the magnetic field sensor is arranged outside a cylindrical envelope of the first clutch element and of the second clutch element which is coaxial with the axis of rotation.

12. The clutch according to claim 9, wherein at least one of the first magnetic field influencing element and the second magnetic field influencing element is configured as a further magnetic field source, which is connected or integrally designed with the other of the first clutch element and the second clutch element.

13. The clutch according to claim 9, wherein the clutch comprises a guard element which is arranged at least partially around the first clutch element and the second clutch element, and wherein the magnetic field sensor is attached to the guard element.

14. A universal joint shaft assembly, comprising:
a rotatably arranged universal joint shaft element, and
the clutch according to claim 9,
wherein the universal joint shaft element is connected to the first clutch element.

15. A method for detecting slip between a first clutch element and a second clutch element of a clutch, the method comprising:
arranging a magnetic field source at one of the first clutch element and the second clutch element, wherein the magnetic field source generates an initial magnetic field;
providing a first magnetic field influencing element on the first clutch element or as an integral part of the first clutch element;
providing a second magnetic field influencing element on the second clutch element or as an integral part of the second clutch element;
arranging the magnetic field source, the first magnetic field influencing element and the second magnetic field influencing element relative to one another such that the initial magnetic field is converted into a superimposed magnetic field by; and
detecting a change in the superimposed magnetic field based on a parameter characterizing the superimposed magnetic field.
